(19) United States
(12) Patent Application Publication
(10) Pub. No.: US 2016/0192810 A1
(43) Pub. Date: Jul. 7, 2016

(54) FREE FLOATING MIXING BLADE

(71) Applicant: Jeff Andrew Knapp, Omaha, NE (US)

(72) Inventor: Jeff Andrew Knapp, Omaha, NE (US)

(21) Appl. No.: 14/947,073

(22) Filed: Nov. 20, 2015

Related U.S. Application Data
(60) Provisional application No. 62/100,403, filed on Jan. 6, 2015.

(51) Int. Cl. A47J 43/27

(52) U.S. Cl. CPC A47J 43/27

(57) ABSTRACT

A free floating spirally shaped mixing blade for use in a mixing chamber for mixing various substances including an elongated blade member formed so as to extend from a first end portion to a second end portion in a spiral configuration, the blade member being positionable so as to be wholly contained within a mixing chamber and free floating therein when the mixing chamber is agitated. In various embodiments, the mixing blade may include a slit positioned at an intermediate location along the length of the blade member dividing the blade member into first and second blade portions, the slit extending partially along the width of the elongated blade, and/or a plurality of openings extending through the blade member for increasing turbulence when the blade is agitated within a mixing chamber. In some embodiments, the mixing blade may take the form of an elliptical helix or a circular helix.

### CROSS REFERENCE TO RELATED APPLICATIONS

This application is a non-provisional application claiming priority to Provisional Patent Application Ser. No. 62/100,403 filed Jan. 6, 2015, the entire disclosure of which is incorporated herein by reference.

### FIELD OF THE INVENTION

The present invention relates generally to a device for improved mixing of solids, powders and various combinations thereof with a fluid or other substance within a container and, more particularly, to a free floating physically independent blade that is formed in a coiled or spiral shape with holes and other geometric features for enhancing the mixing and agitation of the solids/powders with the particular fluid or other substance within a container to achieve the desired beverage. The functionality of the present blade may be suitable for additional applications outside of the realm of beverage mixing, for example, mixing eggs, paint, salad dressings, or other materials.

### BACKGROUND OF THE INVENTION

The use of dietary supplements in drink form is on the rise, especially among teens and young adults, particularly those who regularly exercise. According to at least one-survey, nearly 35% of adolescent, males and females have used protein powders in shakes. Dietary supplement drinks that were once part of a body building subculture have made their way to amateur athletes and now into the main stream. Dietary supplement beverages and powders are being marketed to athletic middle-aged men, post-pregnancy mothers, vegetarians, and those recovering from surgery as healthy alternatives to unhealthy snacks and as other meal replacements. As the use of dietary supplement beverages has increased, a number of devices have been created to improve the mixing of these beverages.

Devices currently on the market for mixing dietary supplement beverages include a number of drawbacks. One such beverage mixing device is disclosed in U.S. Pat. No. 6,379,032, titled “flow-through agitator.” The mixing device disclosed in the '032 Patent includes a wire frame object with interstitial spaces for allowing the flow of liquids and powders into and out of the interior of the wire frame object. Because of its open wire frame shape, the '032 Patent mixing device often fails to completely and homogenously mix powder and other solids with a liquid and it fails to slice through a soft solid such as a banana or other fruit to more substantially mix the solid substance with the liquid. Further, the disclosed mixing device of the '032 Patent is substantially spherical in shape and, as a result, it has a hard time reaching the corner portions of a bottle or container into which it is positioned so as to break up and mix any protein powder or other soft solids stuck in a corner portion of the bottle or mixing chamber.

Other known mixing or stirring devices, such as those described in U.S. Pat. Nos. 4,359,283 and 4,393,940, as well as U.S. Patent Application Publication No. 2010/0208549, all disclose a rotatable shaft attached to the lid of a beverage pitcher and extending substantially along the entire length of the pitcher, the shaft including radially extending vanes and being rotatable by a handle or other means associated with lid. Rotation of the handle or the lid in these prior art stirring devices causes rotation of the vanes to produce agitation within the pitcher along the longitudinal axis of the pitcher.

The present invention aims to introduce a free floating mixing blade which can be used for dietary supplement beverages and other applications, and which is not attached to a container lid or any other structure and which has highly efficient free floating mixing characteristics that efficiently and homogenously mixes powders, liquids, and soft solids.

### SUMMARY OF THE INVENTION

The present invention is a mixing blade for homogenously mixing liquids, powders, solids, soft solids and combinations thereof such that they create a homogenous beverage or other substance. The mixing blade is preferably placed in a bottle, container or other mixing chamber along with a mixture, like a protein powder or other dietary supplement, and a liquid, and subsequently shaken by a user until the beverage or other substance is homogenous. The present mixing blade is an elongated blade member having first and second opposed end portions and is formed so as to extend vertically from its first end portion to its second end portion in a spiral, coiled and/or helical configuration, the elongated blade circumscribing at least about 270 degrees of one complete revolution as it spirals vertically from the first end portion to the second end portion. The present blade member is positionable within a mixing chamber so as to be wholly contained and free floating therewithin when a liquid or other substance is added to the mixing chamber and the mixing chamber is shaken or agitated.

Preferably, the present blade member is in the shape of a helix, either an elliptical or circular helix, although a free floating coiled or spiral shaped elongated blade will likewise work well. The helix shape of the mixing blade may start at the minor or major axis of an ellipse, or at a point on the circumference of a circle or other non-linear shape, and spiral downwardly along a vertical extension of the helical or other geometrical shape until the opposite end of the blade completes at least about 270 degrees of one revolution. In the case of an elliptical helix, the blade may start at either the minor or major axis of the ellipse, or at some other location, and spiral elliptically downward until its opposite end again reaches at least the minor or major axis, or completes at least about 270 degrees of one revolution. In the case of a circular helix, the blade will spiral downwardly until it traverses at least about 270 degrees of one complete revolution around the circumference of the circle.

The elliptical helix shape preferably includes two blade portions separated by a slit, slot or other gap therebetween. The slit or slot may include inner surfaces formed by the opposed end portions of the two blade portions, which end portions having substantial surface areas so as to increase turbulence when the mixing blade is shaken within a container or other mixing chamber. Rib portions may run along the length of the mixing blade at both its top and bottom portions to add support to the blade structure. One or both of the rib portions may include a thickness greater than the thickness of the blade portions such that more friction is generated when the mixing device is shaken within a container or bottle, and therefore the beverage is more agitated and homogenously blended. Also, the elliptical helix mixing blade may include holes that may be arranged in a plurality of different patterns to allow fluid to flow through the blade portions and further agitate and mix the contents of the beverage.

In alternative embodiments, the present mixing blade may be a continuous single helically blade shape with no slit or slot between any blade portions and/or with no holes for further agitating the beverage during the mixing process. In some embodiments, the present mixing blade may complete more than one revolution, and in other embodiments the helix shape may start and finish at a predetermined reference point along a vertically projected circumference of an elliptical helix.

In still another embodiment, the mixing blade may be a circular helix shape. Like the elliptical helix mixing blade, the circular helix mixing blade may include a slit or slot located between blade portions, rib portions that extend along its length, and/or a plurality of holes. In alternative embodiments, the circular helix mixing blade may likewise be a continuous integral helix shape with no slit or holes to further facilitate mixing.

Other aspects and advantages of the present invention will be apparent from the following detailed description of the various embodiments and the accompanying drawings.

### DESCRIPTION OF THE DRAWINGS

In the accompanying drawings, which form a part of the specification and are to be read in conjunction therewith in which like reference numerals are used to indicate like or similar parts in the various views:

FIG. 1 illustrates a front elevational view of the present elliptical helix mixing blade inside a conventional container or mixing chamber, the present mixing blade being constructed according to the teachings of the present invention.

FIG. 2 illustrates a top plan view of the elliptical helix mixing blade of FIG. 1.

FIG. 3 illustrates a left side elevational view of the elliptical helix mixing blade of FIGS. 1 and 2.

FIG. 4 illustrates a front elevational view of the elliptical helix mixing blade of FIGS. 1-3.

FIG. 5 illustrates a right side elevational view of the elliptical helix mixing blade of FIGS. 1-4.

FIG. 6 illustrates an isometric view of the elliptical helix mixing blade of FIGS. 1-4 showing a notch associated with a first portion of the blade.

FIG. 7 illustrates an enlarged portion of the notch associated with the elliptical helix mixing blade of FIG. 6.

FIG. 8 illustrates another isometric view of the elliptical helix mixing blade of FIGS. 1-6 showing a notch associated with a second portion of the blade.

FIG. 9 illustrates an enlarged portion of the notch associated with the elliptical helix mixing blade of FIG. 8.

FIG. 10 illustrates a bottom plan view of the elliptical helix mixing blade of FIGS. 2-6.

FIG. 11 illustrates a top plan view of an alternative embodiment of the elliptical helix mixing blade of FIGS. 1-10.

FIG. 12 illustrates a front elevational view of the elliptical helix mixing blade of FIG. 11.

FIG. 13 illustrates a bottom plan view of the elliptical helix mixing blade of FIGS. 11 and 12.

FIG. 14 illustrates a top plan view of another alternative embodiment of the elliptical helix mixing blade of FIGS. 1-10.

FIG. 15 illustrates a front elevational view of the elliptical helix mixing blade of FIG. 14.

FIG. 16 illustrates a bottom plan view of the elliptical helix mixing blade of FIGS. 14 and 15.

FIG. 17 illustrates a top plan view of still another alternative embodiment of the elliptical helix mixing blade of FIGS. 1-10.

FIG. 18 illustrates an isometric view of the elliptical helix mixing blade of FIG. 17.

FIG. 19 illustrates a front elevational view of the elliptical helix mixing blade of FIGS. 17 and 18.

FIG. 20 illustrates a bottom plan view of the elliptical helix mixing blade of FIGS. 17-19.

FIG. 21 illustrates a top plan view of still another alternative embodiment of the elliptical helix mixing blade of FIGS. 1-10.

FIG. 22 illustrates an isometric view of the elliptical helix mixing blade of FIG. 21.

FIG. 23 illustrates a front elevational view of the elliptical helix mixing blade of FIGS. 21 and 22.

FIG. 24 illustrates a bottom plan view of the elliptical helix mixing blade of FIGS. 21-23.

FIG. 25 illustrates a top plan view of still another alternative embodiment of the elliptical helix mixing blade of FIGS. 1-10.

FIG. 26 illustrates an isometric view of the elliptical helix mixing blade of FIG. 25.

FIG. 27 illustrates a front elevational view of the elliptical helix mixing blade of FIGS. 25 and 26.

FIG. 28 illustrates a bottom plan view of the elliptical helix mixing blade of FIGS. 25-27.

FIG. 29 illustrates a top plan view of still another embodiment of the elliptical helix mixing blade of FIGS. 25-28.

FIG. 30 illustrates a front elevational view of the elliptical helix mixing blade of FIG. 29.

FIG. 31 illustrates an isometric view of the elliptical helix mixing blade of FIGS. 29 and 30.

FIG. 32 illustrates a top plan view of a still further alternative embodiment of the elliptical helix mixing blade of FIGS. 25-28.

FIG. 33 illustrates a front elevational view of the elliptical helix mixing blade of FIG. 31.

FIG. 34 illustrates a bottom plan view of the elliptical helix mixing blade of FIGS. 32 and 33.

FIG. 35 illustrates a top plan view of a still further alternative embodiment of the elliptical helix mixing blade of FIGS. 25-28.

FIG. 36 illustrates a front elevational view of the elliptical helix mixing blade of FIG. 35.

FIG. 37 illustrates a bottom plan view of the elliptical helix mixing blade of FIGS. 35 and 36.

FIG. 38 illustrates a top plan view of a circular helix mixing blade constructed according to the teachings of the present invention.

FIG. 39 illustrates an isometric view of the circular helix mixing blade of FIG. 38.

FIG. 40 illustrates a front elevational view of the circular helix mixing blade of FIGS. 38 and 39.

FIG. 41 illustrates a side elevational view of the circular helix mixing blade of FIGS. 38-40.

FIG. 42 illustrates a bottom plan view of the circular helix mixing blade of FIGS. 38-41.

FIG. 43 illustrates a top plan view of an alternative embodiment of the circular helix mixing blade of FIGS. 39-42.

FIG. 44 illustrates an isometric view of the circular helix mixing blade of FIG. 43.

FIG. 45 illustrates a front elevational view of the circular helix mixing blade of FIGS. 43 and 44.

FIG. 46 illustrates a bottom plan view of the circular helix mixing blade of FIGS. 43-45.

FIG. 47 illustrates a top plan view of another alternative embodiment of the circular helix mixing blade of FIGS. 39-42.

FIG. 48 illustrates a front elevational view of the circular helix mixing blade of FIG. 47.

FIG. 49 illustrates a bottom plan view of the circular helix mixing blade of FIGS. 47 and 48.

FIG. 50 illustrates a top plan view of a further alternative embodiment of the circular helix mixing blade of FIGS. 39-42.

FIG. 51 illustrates a front elevational view of the circular helix mixing blade of FIG. 50.

FIG. 52 illustrates a bottom plan view of the circular helix mixing blade of FIGS. 50 and 51.

FIG. 53 illustrates a front elevational view of two (2) of the present mixing blades inside a conventional container or mixing chamber.

### DETAILED DESCRIPTION OF THE INVENTION

The present invention will be described with reference to the drawing figures in which like reference numerals refer to like parts. For purposes of clarity in illustrating the various features and characteristics of the present invention, proportional relationship of the various elements have not necessarily been maintained throughout the drawing figures.

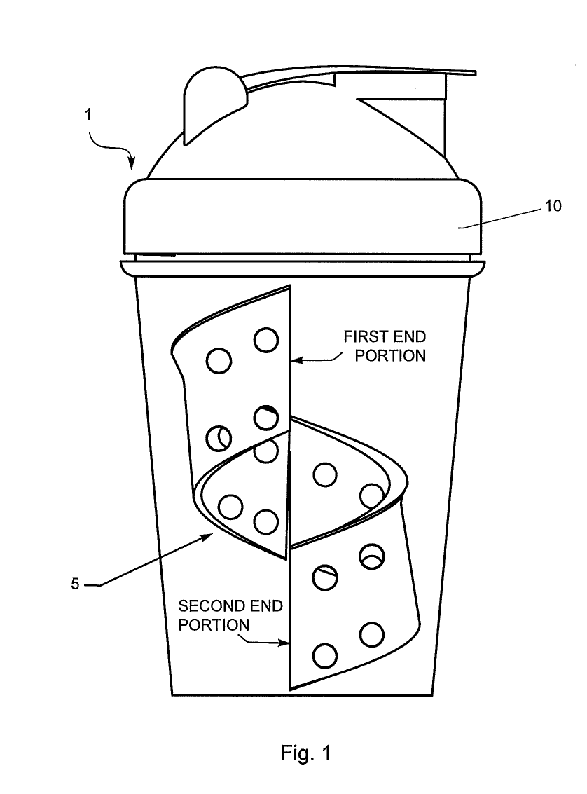

Referring to the drawings more particularly by reference numbers wherein like numerals refer to like parts, FIG. 1 illustrates one embodiment of the present free floating spirally shaped mixing blade inserted within a typical container or mixing chamber 1 for operational use. More particularly, FIG. 1 discloses an elongated blade member that is physically independent of any other structures and is positionable within a container or mixing chamber 1 so as to be wholly contained therewithin. Blade member 5 includes first and second opposed end portions (FIG. 1) and is formed, so as to extend vertically as shown in FIG. 1 from the first end portion to the second end portion in a spiral and/or helical configuration. The mixing blade 5 circumscribes at least about 270 degrees of one complete revolution, and preferably at least one complete 360 degree revolution, as it spirals vertically downwardly from its first end portion to its second end portion. Blade member 5 is free floating when positioned within the container 1 when a fluid, liquid or other substance is added thereto and container 1 is shaken and agitated such that any beverage or other mixture located therein is thoroughly and homogenous mixed.

In order to mix a beverage or other liquids, solids and/or soft solids, container 1 is used in combination with mixing blade 5 by shaking the container up and down and side to side to mix the liquids, solid/liquid suspensions and/or powdered solids within the container. A consumer may mix a dietary supplement beverage or other substance in need of mixing by introducing a liquid or other substance into container 1 before subsequently introducing a powder, fruit or other substance to be mixed with the liquid within container 1. Container 1 and mixing blade 5 may be used to mix a variety of liquids and/or semisolids as will be understood by those skilled in the art, and use of the present free floating mixing blade creates a well dispersed substantially homogeneous beverage. For example, container 1 and mixing blade 5, or an alternative embodiment thereof as will be hereinafter further explained, may also be used to homogeneously mix a wide variety of various materials, including, but not limited to, eggs, paint, salad dressings, powders, water, solid suspensions, viscous fluids and other food and fluid products.

After the substances to be mixed have been placed in a container or bottle 1, a user should ensure that a cover such as lid 10 illustrated in FIG. 1 is secured to container 1. A user may then shake container 1 such that mixing blade 5 is agitated within container 1 and creates a turbulence that promotes the mixing of substances contained therewithin. A user may continue to shake container 1 until the substance is sufficiently homogeneously mixed. This shaking can be done in all directions, up and down, side to side, at an angle, including rotation and much more. The ability to move the present free floating mixing blade within a particular container out performs the known mixing blade structures, many of which are not free floating but instead are attached to the cover or lid of the container, and the present blade provides more turbulence and agitation within the container so as to provide a well dispersed, substantially homogeneous suspension of all of the materials or items combined within container 1. The various components and features of mixing blade 5 and various alternative embodiments thereof, as well as the benefits and characteristics of the various mixing blades, are described in greater detail below.

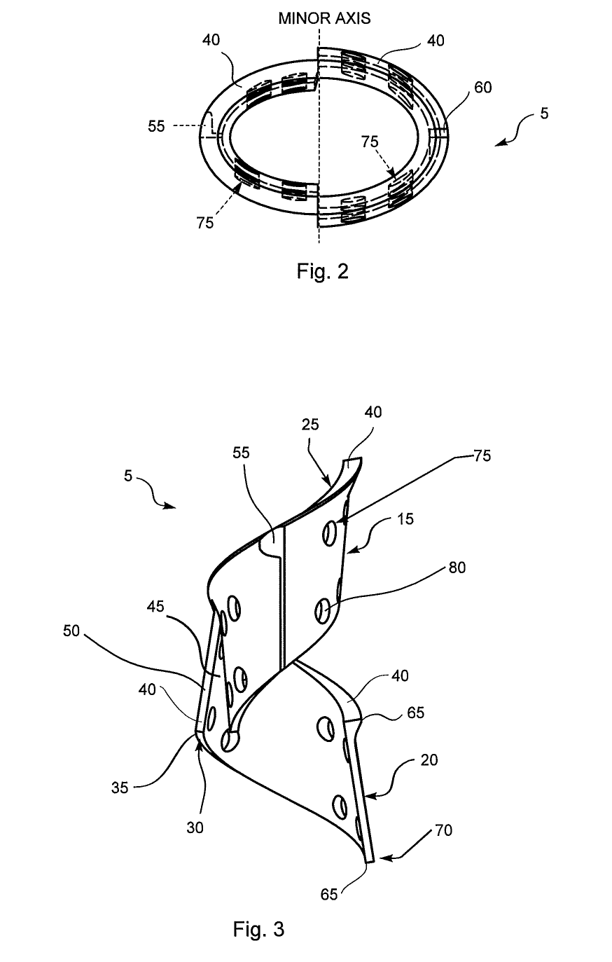

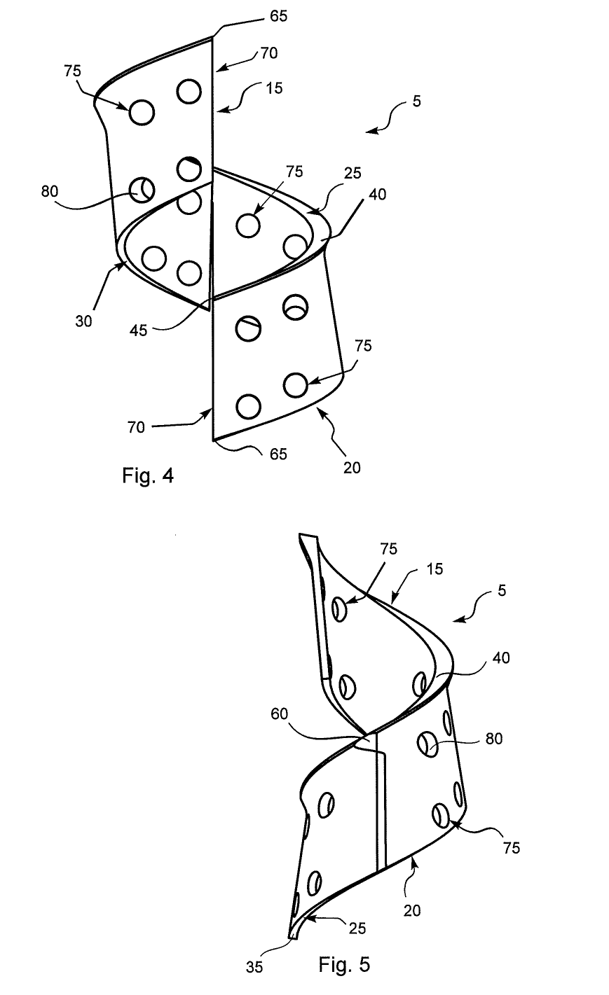

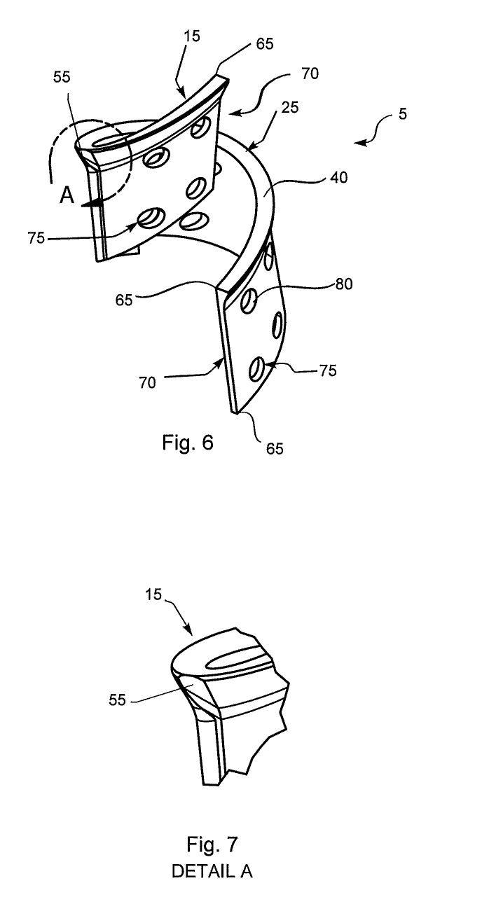

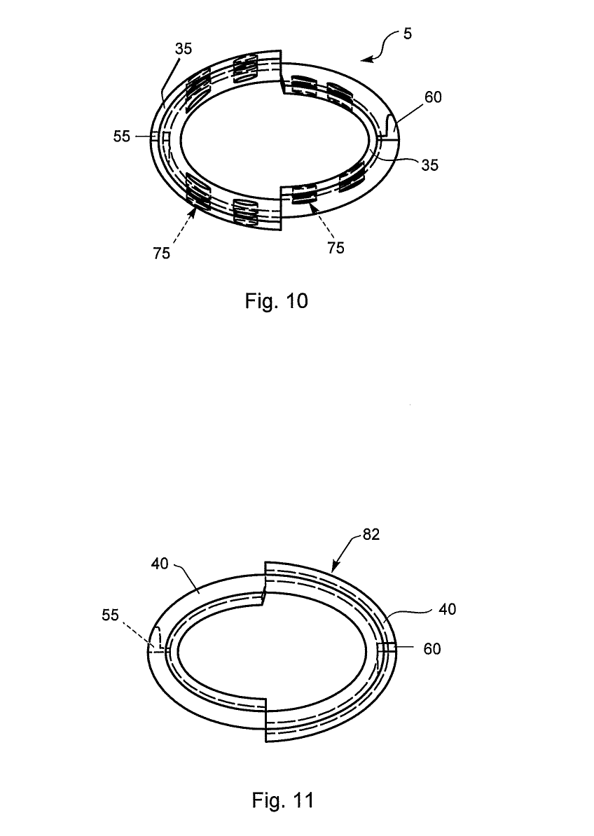

FIGS. 2-10 illustrate various views of one embodiment of an elliptical helix mixing blade 5 shown in FIG. 1. FIG. 2 illustrates a top plan view of mixing blade 5 and mixing blade 5 is described as elliptical because, when viewed from the top, such as shown in FIG. 2, mixing blade 5 has a generally elliptical shape as it spirals downwardly as illustrated in FIGS. 3-5. As best illustrated in FIGS. 3-6 and FIG. 8, mixing blade 5 generally includes a first blade portion 15 and a second blade portion 20, blade portions 15 and 20 being separated by a slit or slot 45 formed therebetween as will be hereinafter further explained.

As well understood in the art, an ellipse includes both a minor and a major axis. FIG. 2 illustrates the minor axis of the elliptical shape of elliptical helix mixing blade 5, as shown by the dashed line labeled “Minor Axis.” As shown in FIG. 2, and as illustrated in greater detail in FIGS. 3-5 and 10, first blade portion 15 of mixing blade 5 starts at the minor axis and elliptically spirals downwardly and completes at least about 270 degrees of one complete revolution and preferably about 360 degrees of revolution before the second blade portion 20 terminates upon intersecting the minor axis where first blade portion 15 started its downward spiral. In alternative embodiments, the blade portions 15, 20 may vary in basic shape, size and pitch, and may spiral more rapidly so as to complete more revolutions.

The helical shape of mixing blade 5 is preferably supported by an, upper rib 25 that runs the length of mixing blade 5 and a lower rib 30 that also spans the length of mixing blade 5. Ribs 25, 30 act as a structural support for mixing blade 5, reducing stress concentrations at discontinuous regions between blade portions 15, 20 such as at the slit or slot 45. Also, during mixing, drag created by ribs 25, 30 induces rotation of mixing blade 5, thus creating a vortex region in local fluid flow when container 1 or another similar mixing chamber is shaken. The overall contour of ribs 25, 30 may be varied in order to produce increased agitation in a given specific mixture and may include surfaces that are a flat top surface, a rounded top surface, a tilted flat surface, and/or other foreseeable effective shapes. The shape of ribs 25, 30 may also dictate the direction in which container 1 or another volumetric mixing chamber should reciprocate in order to induce agitation based on the normal force of the fluid on ribs 25, 30.

As best illustrated in FIGS. 2, 3-5 and 10, lower rib 30 includes a rib surface 35 of a consistent surface area along the length of mixing blade 5, while upper rib 25 includes a rib surface 40 having a greater surface area along its length as compared to rib surface 35. In alternative embodiments, lower rib 30 may have a rib surface similar to rib surface 40 of upper rib 25 that spans the length of mixing blade 5.

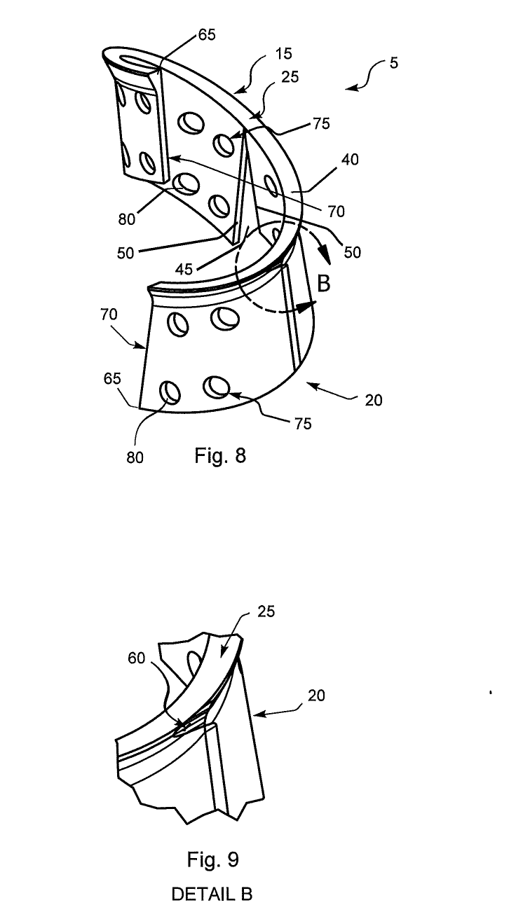

Blade portions 15, 20 are separated in the illustrated embodiment by a slit 45. Blade portions 15, 20 create the turbulence and induce the vortex region in the substances being mixed and agitated. The blade portions 15, 20 follow a similar helical path as ribs 25, 30 but their diameters, major and minor diameters, may differ from that of ribs 25, 30 to induce differing fluid flow while mixing. By moving the diameters of the blade portions so as to produce the slit 45, the fluid flow within the mixing chamber 1 will be directed to either produce an increased dispersion of powders outwardly from the blade 5 or to increase the speed of fluid flow (e.g., vortex depth and velocity) and decreased dispersion as a result of the geometry of blade portions 15, 20. By introducing a large difference or gap between the first blade portion 15 and second blade portion 20 at the slit 45 as best illustrated in FIG. 8, particles within a mixture may experience greater dispersion as they are thrown at a greater angle from the axis of rotation.

Slit 45 preferably includes interior surfaces 50 formed by the opposed end portions of blade portions 15, 20 at slit 45. These surface areas 50 provide additional turbulence when a substance is being mixed in container 1. As shown and illustrated, slit 45 does not merely separate the first blade portion 15 from blade portion 20, but it also widens the gap between blade portions 15, 20 such that first portion 15 is pulled inwardly away from second portion 20 as illustrated in FIG. 8, thus increasing the width or gap of slit 45. By increasing the width of slit 45, greater turbulence can be generated, and the surface area of interior surfaces 50 are unobstructed, thus increasing turbulence and agitation when a beverage or other substance is being mixed.

As shown in FIGS. 3, 5, 6 and 8, and enlarged to show detail in FIGS. 7 and 9, mixing blade 5 may include a first or upper notch 55 and a second or lower notch 60. Upper notch 55 is illustrated in greater detail in FIG. 7, and lower notch 60 is illustrated in greater detail in FIG. 9. Notches 55, 60 may extend vertically downwardly as illustrated in FIGS. 7 and 9 and are formed as part of the manufacturing and tooling process for enabling the mixing blade to be released from the mold or tooling involved with forming the blade 5. The notches 55, 60 also provide additional surfaces for agitating substances being mixed and may further create turbulence and fluid flow around the mixing blade 5. Notches 55 and/or 60 may be located anywhere on mixing blade 5, or alternatively, notches 55, 60 may not exist at all, for example, if mixing blade 5 is manufactured via a 3-D printing (additive manufacturing) or other manufacturing process.

As shown in FIGS. 3, 4, 6, and 8, mixing blade 5 may include sharp corner portions 65 at the respective opposed end portions 70 of blade portions 15, 20. Sharp corner portions 65 allow mixing blade 5 to reach and scrape crevices and other hard to reach locations within the mixing chamber 1 so that residual powder or other solid suspensions are not stuck in container 1. Sharp corner portions 65, as well as the edges associated with opposed blade end portions 70 and blade end surfaces 50, also allow blade portions 15, 20 to slice through soft solids such as, but not limited to, bananas and a wide variety of different fruits and vegetables. Pointed or sharp surfaces such as corner portions 65 provide a substantial improvement over the prior art devices where the mixing device is generally rounded and cannot access hard to reach places similar to those described above nor can the prior art devices easily slice through soft solids like a banana and other fruits and vegetables.

Generally, depending on the type of helix used for any given mixing blade, the amount of turbulence introduced by the mixing blade during mixing in a mixing chamber may also be regulated. For example, if an elliptical helix such as mixing blade 5 is utilized, blade portions 15, 20 may have a relatively broad surface along their major axis and a more abruptly changing curve around their minor axis. Throughout rotation, such a broad, asymmetrical surface may provide considerably more drag than a continuous and symmetrical shape, such as a circular helix mixing blade as will be described later herein. Such an elliptical helix shape increases turbulence and causes better agitation of the mixture along end portions 50, 70 and corner surfaces 65.

Also illustrated in FIGS. 3-6 and 8, holes or openings 75 are associated with mixing blade 5. As shown in the illustrated embodiment, mixing blade 5 includes a plurality of holes 75, though in alternative embodiments, mixing blade 5 may include more or fewer holes 75, or any plurality of holes 75, at any particular location and arranged in any particular pattern along the surface of the blade portions 15, 20. In this regard, any grouping of holes 75 and any spacing between holes 75 is envisioned, recognized and anticipated. When mixing blade 5 is shaken within bottle 1 or a different mixing chamber, more fluid may pass from the inside of mixing blade 5 to the outside of mixing blade 5 via holes 75. This allows for more homogeneous mixing in a shorter amount of time. In addition, varied geometries of inner surface 80 within each hole 75 may further create drag and additional turbulence during the mixing process, which also may increase agitation of the mixture.

Placement of the holes 75 on the blade 5 is driven by at least two factors, induced drag/turbulence and design manufacturability. To maximize the effect of the holes 75 for any particular application, it is necessary to optimize their frontal area (size) and spacing. In one embodiment, mixing blade 5 may include many small holes similar to holes 75 to create a better turbulent boundary layer around the blade. Alternatively, if the transfer of fluid from one side of mixing blade 5 to the other side is prioritized, fewer holes with a larger diameter may be used to increase drag and turbulence. Holes in the blade may vary widely in shape and size including, but not limited to, a circle, oval, ellipse, polyhedron, and other shapes. Similarly, holes 75 or alternatives thereof may be patterned in a nearly limitless number of configurations.

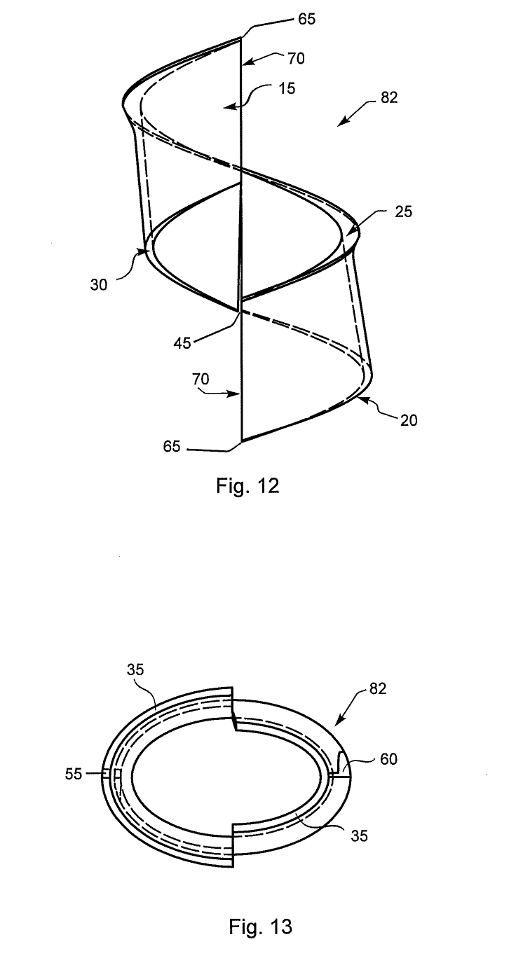

FIGS. 11-13 provide various views of an alternative embodiment of mixing blade 5, namely, elliptical helix mixing blade 82. Mixing blade 82 is substantially similar to mixing blade 5, in all respects, except mixing blade 82 does not include holes 75. As such, mixing blade 82 includes blade portions 15, 20, ribs 25, 30, slit 45, blade end portions 50 and 70, and corner portions 65, and may include notches 55, 60. These elements of blade 82 function and operate as previously explained with respect to mixing blade 5.

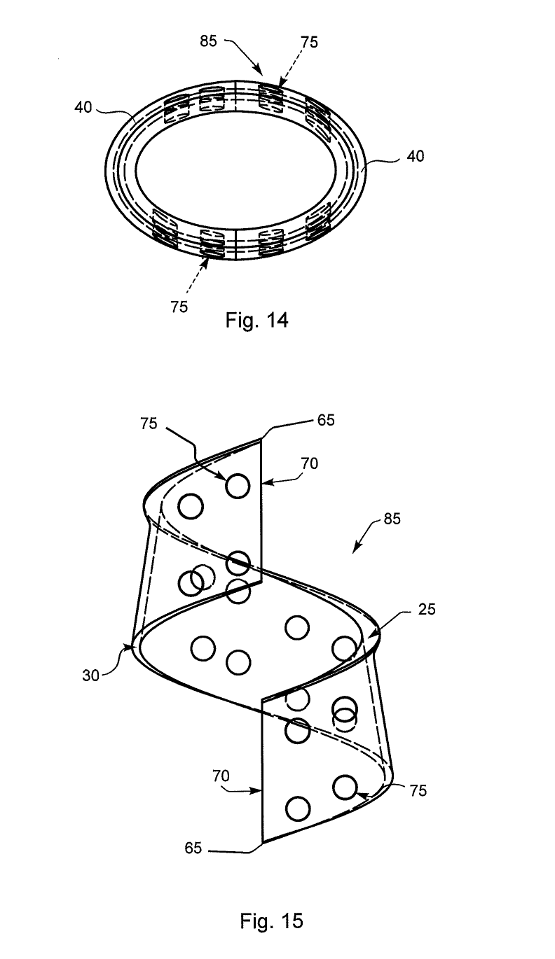

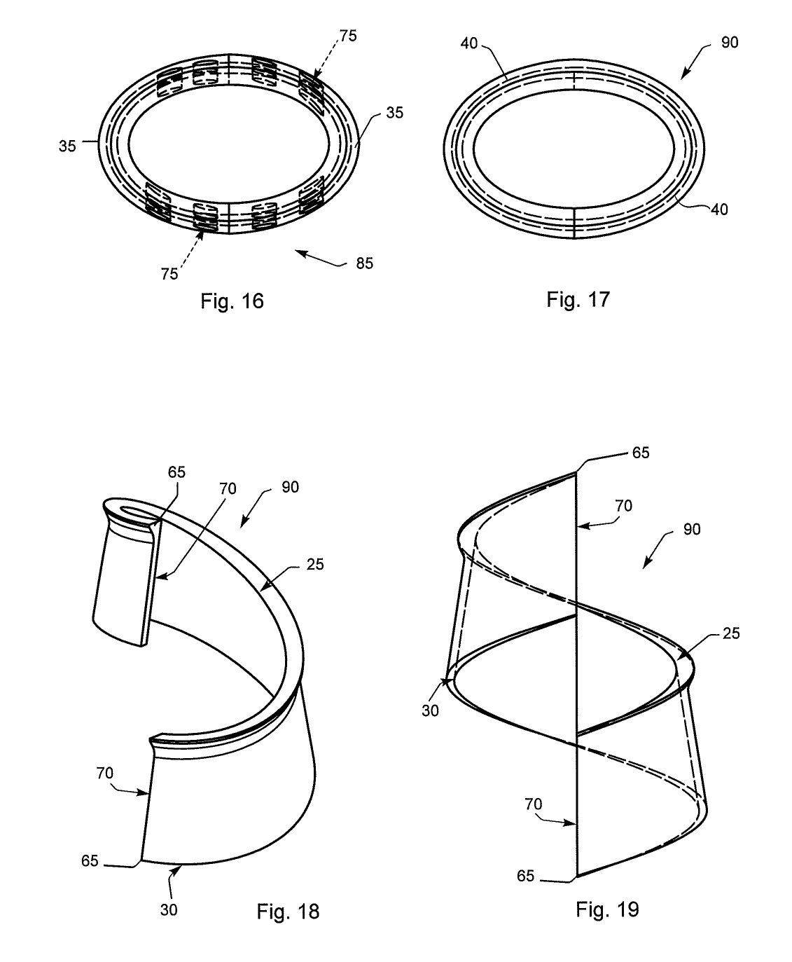

FIGS. 14-16 illustrate yet another alternative embodiment to mixing blade 5, namely elliptical helix mixing blade 85. Mixing blade 85 is substantially identical to mixing blade 5 in all respects except mixing blade 85 does not include slit 45 separating blade 85 into two separate blade portions. Instead, mixing blade 85 is formed as one continuous integral blade. Mixing blade 85 does include holes 75, ribs 25, 30, blade end portions 70, corners 65, and may include notches 55, 60. These elements of blade 85 function and operate as previously explained with respect to mixing blade 5. Because blade 85 does not include slit 45, it likewise does not include blade end portions 50 associated with mixing blade 5.

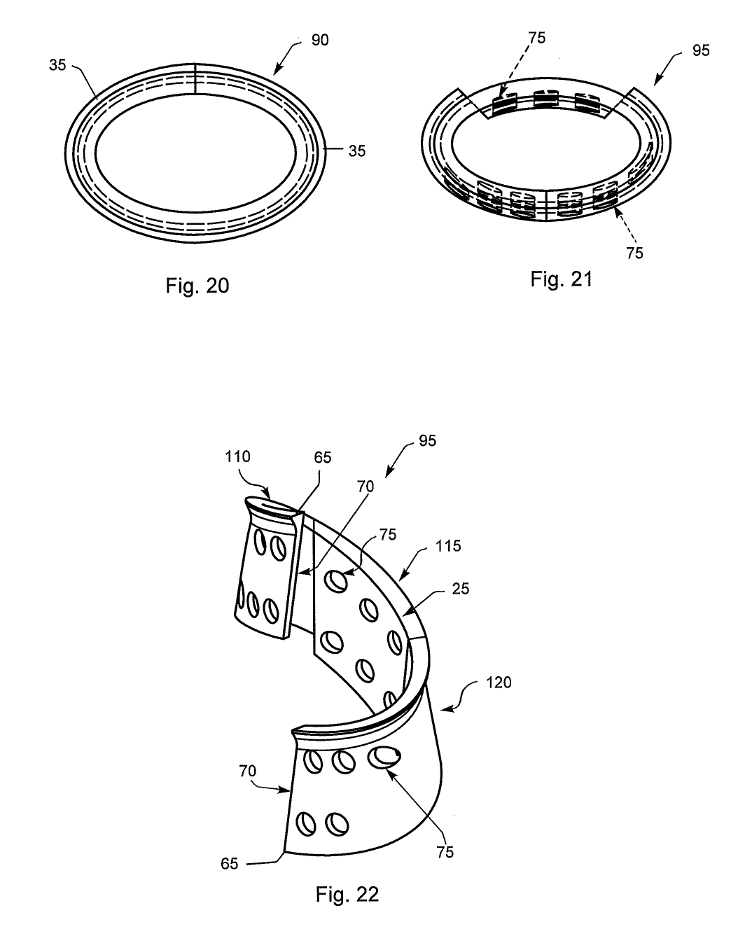

FIGS. 17-20 illustrate yet another alternative embodiment of mixing blade 5, namely, elliptical helix mixing blade 90. Mixing blade 90 is sized and configured substantially similar to mixing blade 5 in all respects except that it does not include the holes 75 and the slit 45. Like mixing blade 85, blade 90 is formed as one continuous integral blade and includes ribs 25, 30, blade end portions 70, corners 65, and may include notches 55, 60. These elements of blade 90 function and operate as previously explained. As a result of omitting holes 75 and slit 45, mixing blade 90 may generate less drag than other embodiments of the present mixing blade, for example, mixing blade 5.

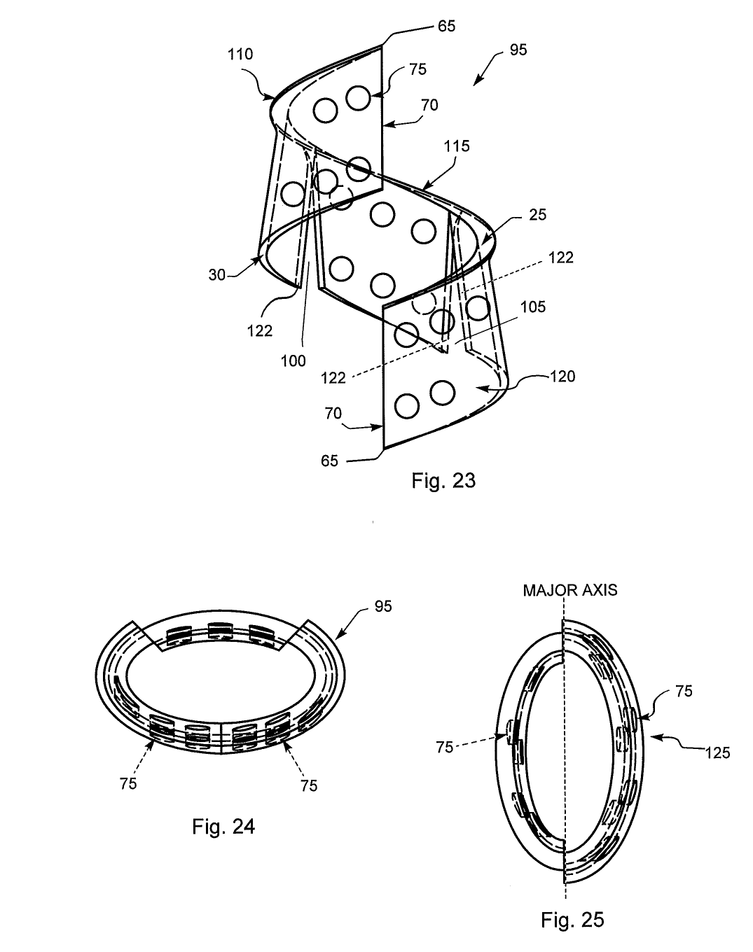

FIGS. 21-24 illustrate still another alternative embodiment of mixing blade 5, namely, mixing blade 95. Unlike mixing blade 5, mixing blade 95 includes two slits, a first slit 100 and a second slit 105, thus dividing mixing blade 95 into three separate blade portions 110, 115 and 120. A first blade portion 110 is separated from a central or second blade portion 115 by first slit 100, and central blade portion 115 is separated from a third blade portion 120 by second slit 105. The slits 100 and 105 may be positioned and located at any predetermined portion along the length of mixing blade 95. As a result of including multiple slits 100, 105 greater drag may be generated, and increased mixing of substances in container 1 or another mixing chamber may be improved. It is also recognized and anticipated that any plurality of slits may be used along the length of blade 95. Mixing blade 95 may likewise include ribs 25, 30, blade end portions 70, corners 65, multiple opposed blade end portions 122 formed by the slits 100 and 105, and may include notches similar to notches 55, 60. In an alternative embodiment of mixing blade 95, holes 75 may be eliminated.

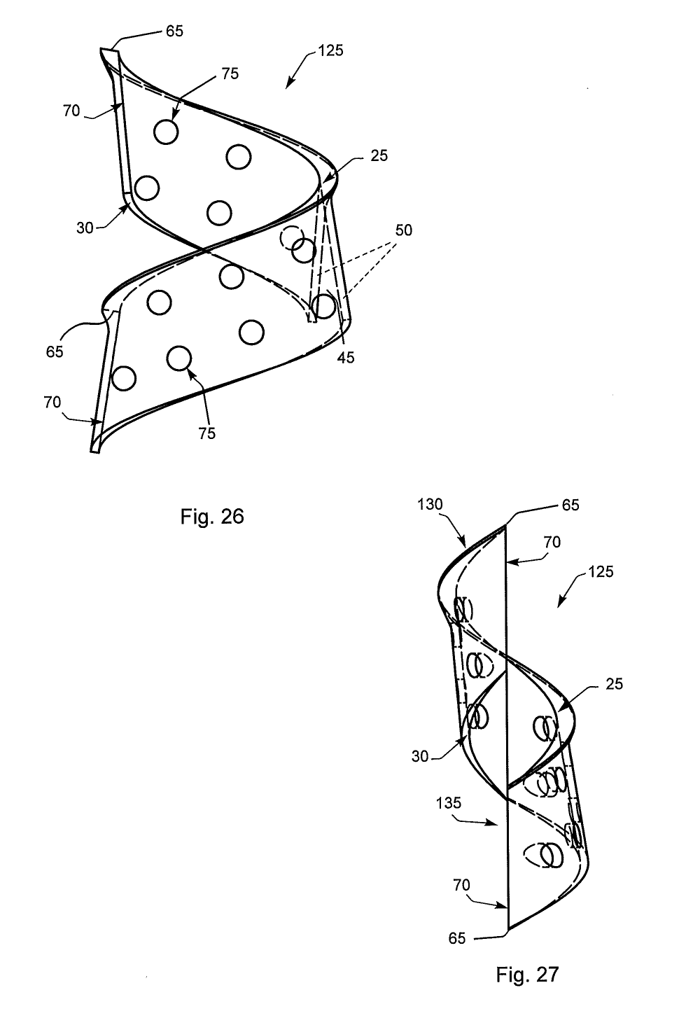

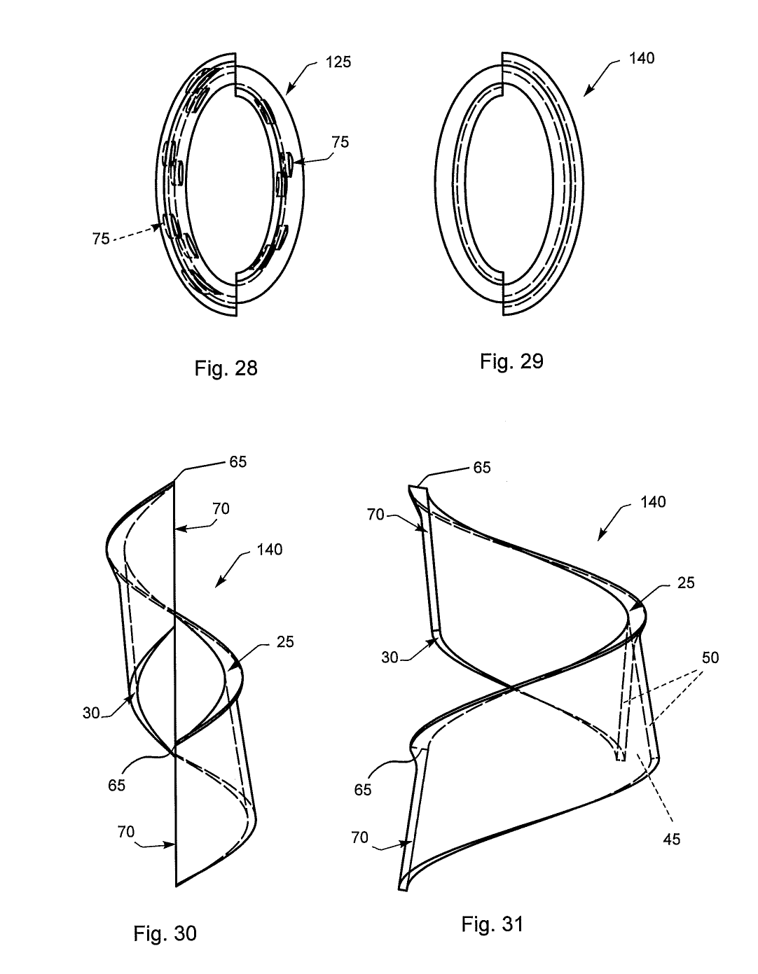

FIGS. 25-28 illustrate yet another alternative embodiment of mixing blade 5, namely, elliptical helix mixing blade 125. As discussed above, when describing mixing blade 5, ellipses include both a major and a minor axis. In FIG. 25, the major axis is shown in dashed lines and is labelled as “Major Axis.” The primary difference between mixing blade 125 and mixing blade 5 is that a first blade portion 130 of mixing blade 125 commences at the major axis rather than the minor axis, and a second blade portion 135 of mixing blade 125 terminates at the opposite side of the major axis after one complete revolution. Such a configuration provides for broader blade portions 130, 135 such that greater turbulence may be introduced in container 1 or another similar mixing chamber. Like mixing blade 5, mixing blade 125 includes holes 75 as well as a slit 45, ribs 25, 30, blade end portions 50 and 70, corners 65, and may include notches similar to notches 55, 60.

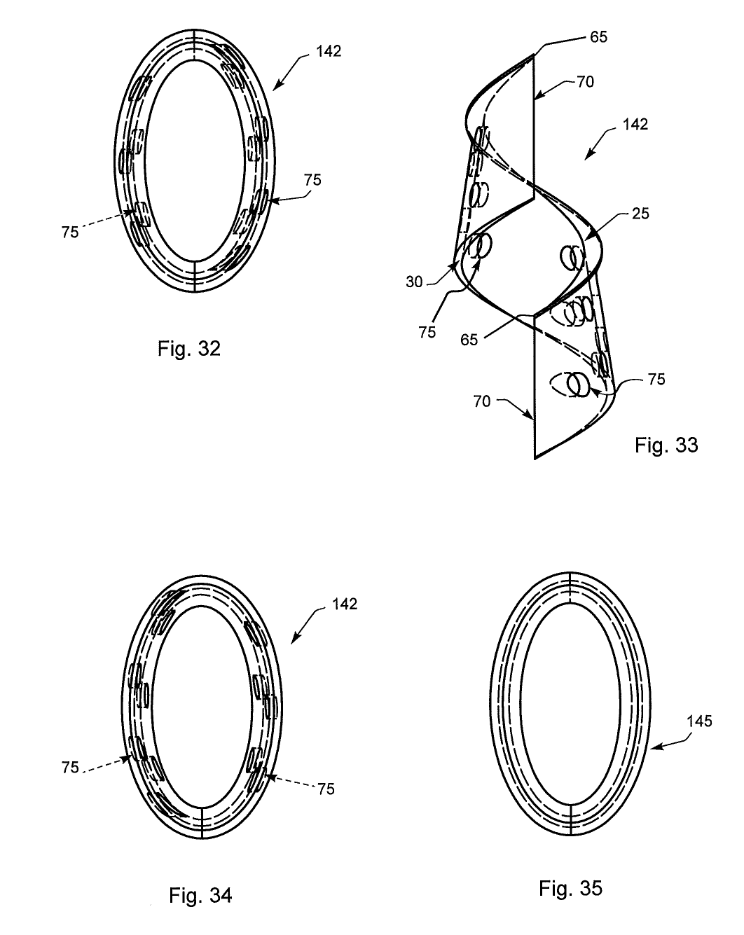

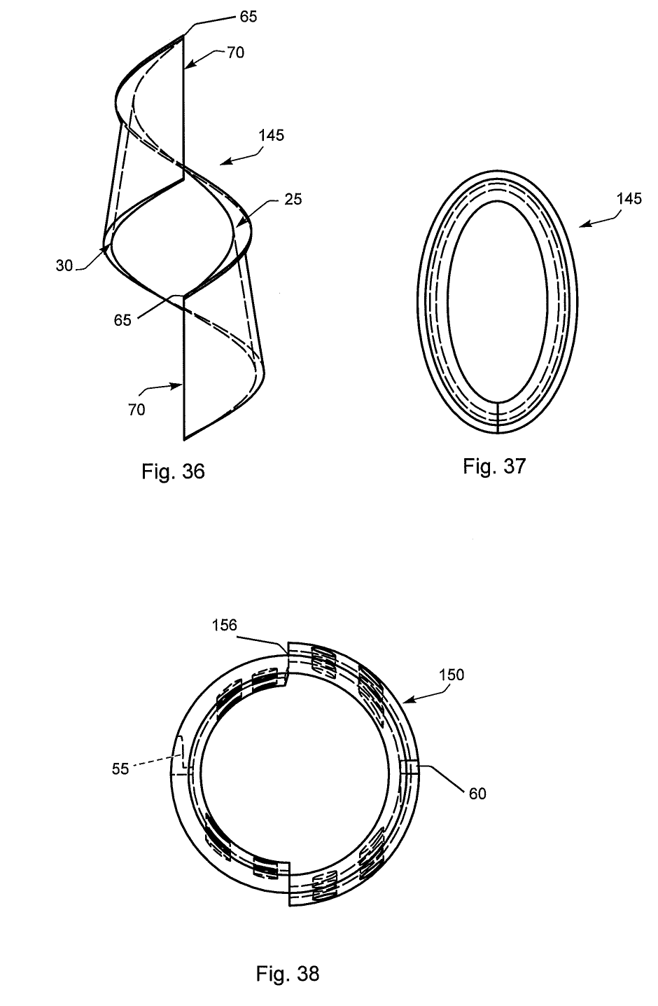

Also like mixing blade 5, mixing blade 125 includes numerous alternatives. For example, in an alternative embodiment illustrated in FIGS. 29-31, elliptical helix mixing blade 140 is substantially similar to mixing blade 125, except that it does not include the holes 75. As such, mixing blade 140 includes ribs 25, 30, the slit 45, blade end portions 50 and 70, corners 65, and may include notches similar to notches 55, 60. Still further, in the alternative embodiment illustrated in FIGS. 32-34, mixing blade 142 is again substantially similar to mixing blade 125, except that it does not include the slit 45. Like mixing blade 90, blade 142 is formed as one continuous integral blade. In yet still another alternative embodiment illustrated in FIGS. 35-37, elliptical helix mixing blade 145 is again constructed substantially similarly to mixing blade 125, except that it does not include the holes 75 and the slit 45. Like mixing blade 142, mixing blade 145 is also formed as one continuous integral blade and includes ribs 25, 30, blade end portions 70, corners 65, and may include notches similar to notches 55, 60. As such, mixing blade 145 generates significantly less drag than the alternative embodiments described hereinabove.

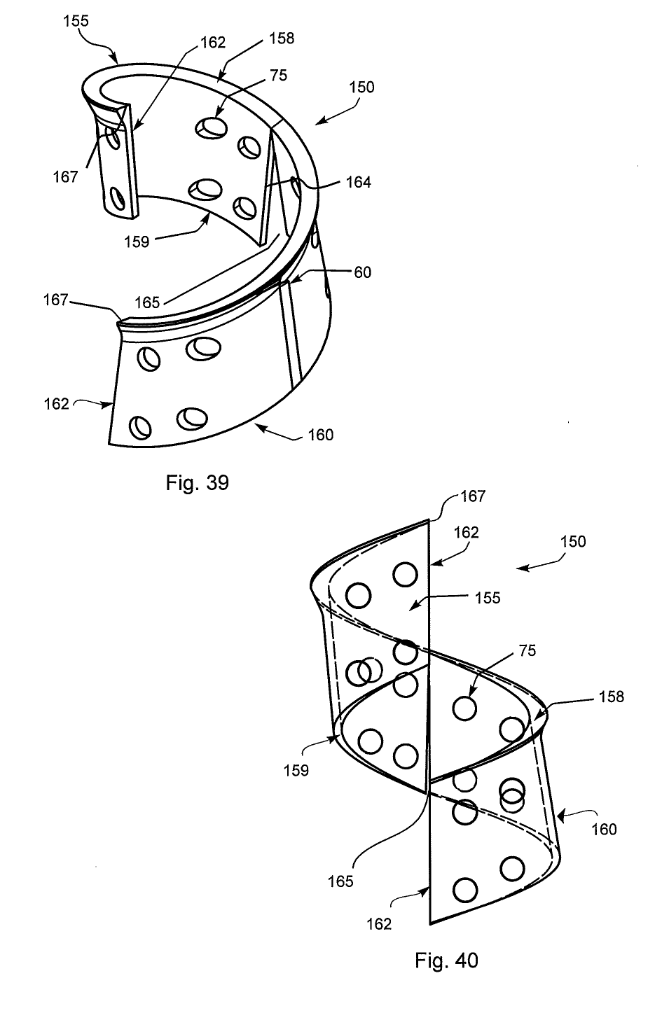

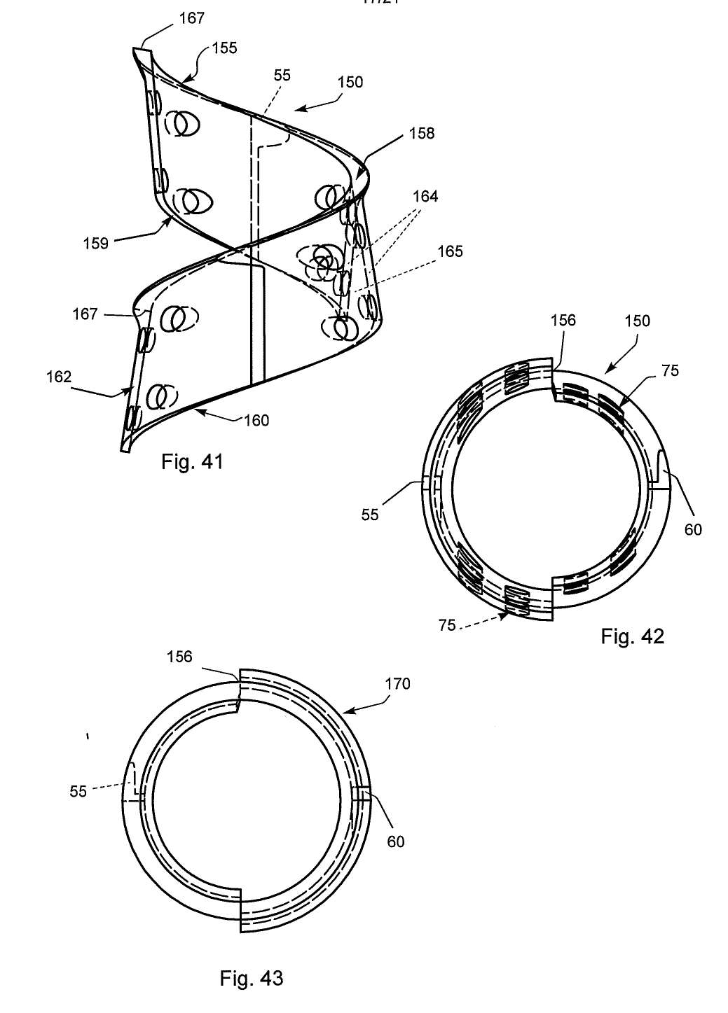

FIGS. 38-42 illustrate various views of a circular helix mixing blade 150. Mixing blade 150 is substantially similar to mixing blade 5, however as shown and illustrated in the top view of FIG. 38, mixing blade 150 is generally circular when viewed from above as it spirals downwardly as illustrated in FIGS. 39-42. Similar to mixing blade 5, mixing blade 150 generally includes a first blade portion 155 and a second blade portion 160, which are separated by a slit 165 formed therebetween. As the first and second blade portions 155 and 160 spiral helically downward, blade portions 155, 160 complete one full 360 degree revolution. The first blade portion 155 can start at any point 156 on the circumference of the circle formed by the vertical extension of the blade portions 155, 160 as illustrated in FIG. 38 and blade portion 160 will terminate when its opposite end portion reaches at least the same vertical extension of point 156, or at least 270 degrees of one revolution. In alternative embodiments, mixing blade portions 155, 160 may vary in basic size, shape and pitch and may spiral more rapidly such that blade portions 155, 160 complete more revolutions. Also similar to mixing blade 5, mixing blade 150 includes a plurality of holes 75 substantially similar to those of mixing blade 5 as well as notches 55, 60 as best illustrated in FIGS. 39 and 41. Also, like mixing blade 5, blade 150 may also include an upper rib 158 and a lower rib 159 that likewise run the length of mixing blade 150, blade end portions 162, blade end portions 164 formed by slit 165, and corner portions 167. All of these similar features function and operate substantially the same as previously explained with respect to mixing blade 5. The circular shape of mixing blade 150 may provide for a larger volume of liquid and other substances traveling through mixing blade 150 when in use. As such, the turbulence generated by mixing blade 150 during the mixing process may be greater than that generated when using the elliptical mixing blade 5 or any of its alternative embodiments.

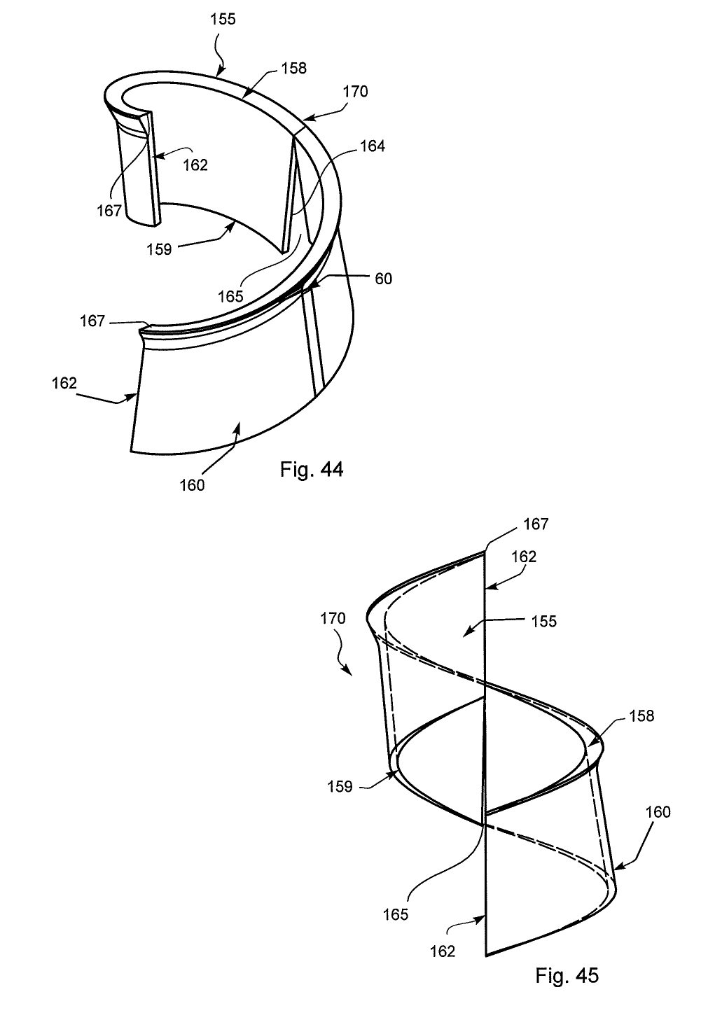

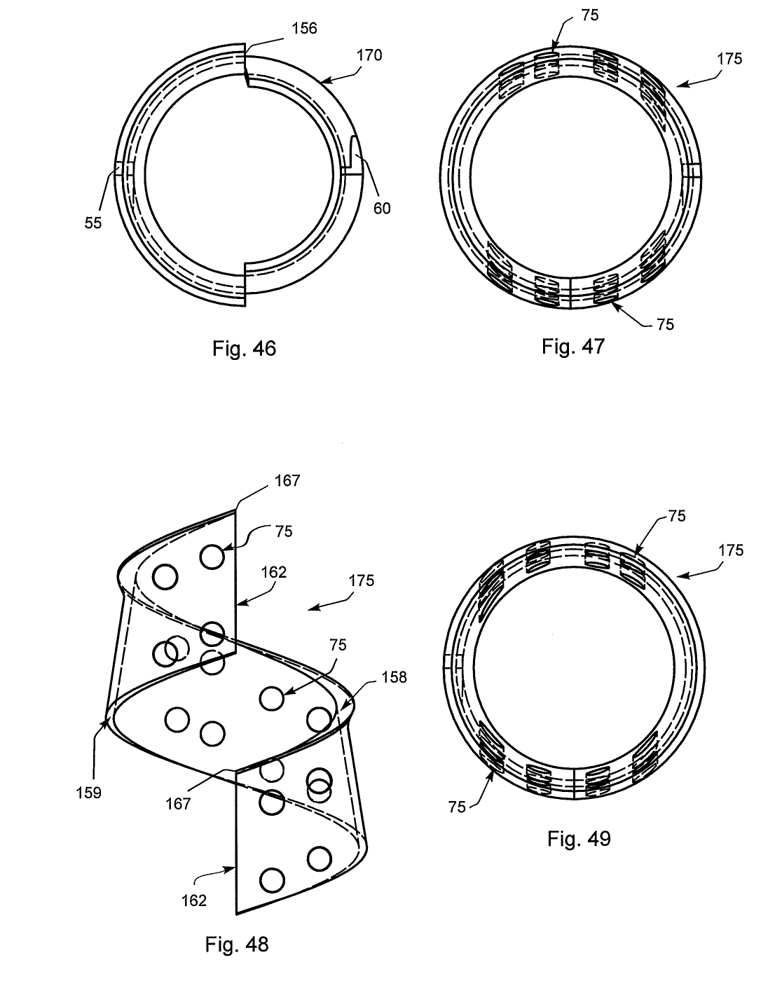

FIGS. 43-46 illustrate an alternative embodiment 170 to the circular helix mixing blade 150 discussed above, wherein mixing blade 170 is substantially identical to mixing blade 150 except that it does not include the holes 75. In all other respects, mixing blade 170 functions and operates in a substantially similar manner as compared to mixing blade 150.

In another alternative embodiment to mixing blade 150 described herein, FIGS. 47-49 illustrate a circular helix mixing blade 175 which is again constructed substantially similar to mixing blade 150 except that mixing blade 175 fails to include slit 165. As such, mixing blade 175 is formed as one integral or continuous blade rather than being divided into two separate blade portions such as blade portions 155, 160 associated with mixing blade 150, and it does not include blade end portions 164 formed by the slit 165.

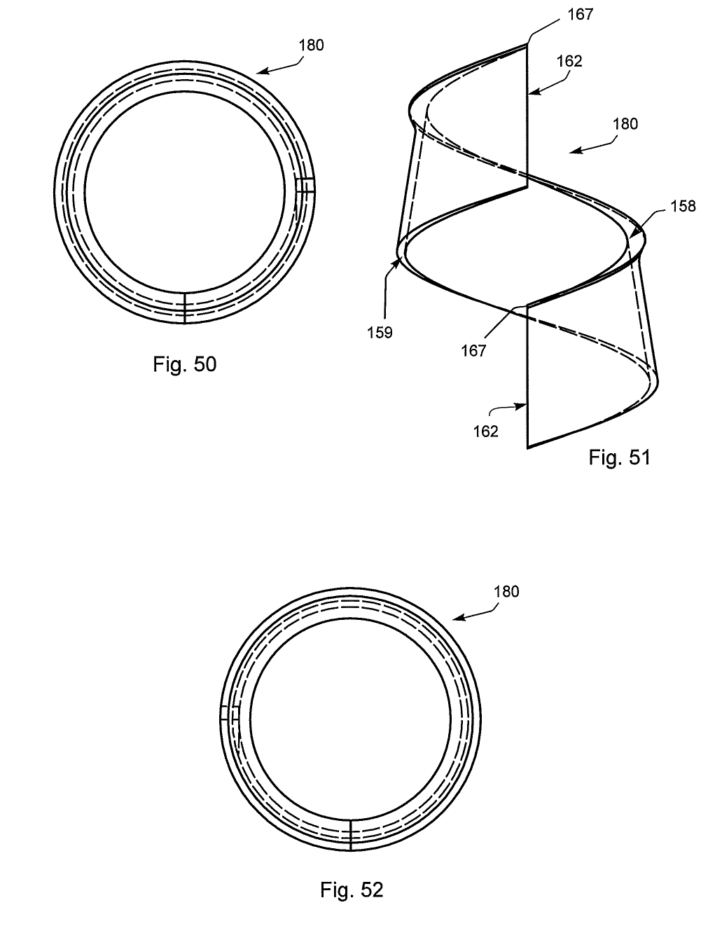

FIGS. 50-52 illustrate yet another alternative embodiment to circular helix mixing blade 150, namely, circular helix mixing blade 180. Mixing blade 180 is again constructed substantially similarly to mixing blade 150, except that it does not include the holes 75 and the slit 165. Like mixing blade 175, blade 180 is formed as one continuous or integral blade and, as such, without holes 75 and no slit 165, it may generate substantially less drag than mixing blade 150.

Generally, the various mixing blades disclosed herein may be composed of many varying materials. For example, the mixing blades may be made of, but are not limited to, polymers, elastomers, metals, ceramics, or even a dissolvable powder including dietary supplements. In the embodiment where the mixing blades are composed of a dissolvable dietary supplement, the mixing blades would be for single use. Varying materials allow for the various disclosed mixing blades to be designed around numerous applications, with the ability to change density, toughness, hardness, strength, and other important mechanical, chemical, electromagnetic, and thermal properties.

It is also recognized and anticipated that the overall size, shape, pitch and length of each of the various blade embodiments can take on a wide variety of different sizes, shapes, pitches and lengths depending upon the particular application and the particular container or mixing chamber into which the present mixing blades will be used, so long as the present blades are free floating and spiral from one end portion to its opposite end portion as described above.

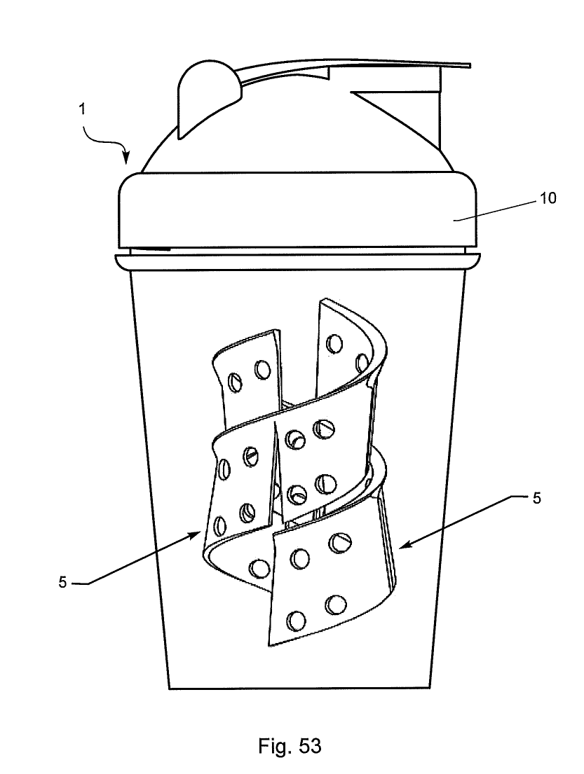

It is also recognized and anticipated that any number of the various embodiments of the present mixing blades such as mixing blades 5, 82, 85, 90, 95, 125, 150, 170, 175 and/or 180 can be incorporated into a container or other mixing chamber for operational use. More particularly, as illustrated in FIG. 53, two of the present mixing blades 5 are illustrated inside container or mixing chamber 1 for mixing and enhancing the agitation of solids, powders, and/or any other substance with a particular fluid or other substance as explained above. It is also recognized and anticipated that different configurations of the present mixing blade can be inserted into a single container or mixing chamber, and that any number of such blades can be housed within such container or mixing chamber depending upon the overall size of the container/mixing chamber. Increasing the number of the present mixing blades within a container or mixing chamber can increase the mixing and agitation of the various elements and substances contained therein.

The present mixing blades disclosed and described above, being physically independent from container 1 or another similar mixing chamber, may be easily removed from a mixture after use and cleaned independently from container 1, for example, in a dishwasher. Alternatively, the present mixing blades may be cleaned simply by placing the mixing blade in a mixing chamber such as container 1 and adding appropriate cleaning agents thereto, such as water and dishwashing soap. By shaking or otherwise agitating the cleaning agent mixture, along with the mixing blade within the container 1 or other mixing chamber, effective removal of powders, liquids, and other debris from the blade can be achieved.

The constructions described above and illustrated in the drawings are presented by way of example only and are not intended to limit the concepts and principles of the present invention. Thus, there has been shown and described several embodiments of a novel free floating spirally shaped mixing blade. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present mixing blade constructions will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A free floating spirally shaped mixing blade for mixing viscous fluids, liquids, solids, solid/liquid suspensions, solid/solid suspensions and/or powdered substances within a mixing chamber, the mixing blade comprising:
an elongated blade member having first and second opposed end portions, said blade member being formed so as to extend from said first end portion to said second end portion in a spiral configuration, said blade member circumscribing at least about 270 degrees of one complete revolution as it spirals from said first end portion to said second end portion;
said blade member being positionable within a mixing chamber so as to be wholly contained therewithin;
said blade member being free floating within the mixing chamber when the mixing chamber is agitated.

2. The free floating mixing blade of claim 1 wherein said elongated blade member includes a plurality of holes extending therethrough.

3. The free floating mixing blade of claim 1 wherein said elongated blade member includes a rib portion extending along the full length of said blade member, said rib portion providing additional support to said elongated blade member.

4. The free floating mixing blade of claim 1 wherein said elongated blade member includes at least one slit positioned and located at an intermediate location along the length thereof, said at least one slit dividing said elongated blade member into a first blade portion and a second blade portion.

5. The free floating mixing blade of claim 4 wherein said at least one slit forms a gap between said first blade portion and said second blade portion at said slit.

6. The free floating mixing blade of claim 5 wherein said first blade portion and said second blade portion are offset from each other at said at least one slit.

7. The free floating mixing blade of claim 1 wherein said elongated blade member forms an elliptical helix.

8. The free floating mixing blade of claim 4 wherein said elongated first and second blade portions form an elliptical helix.

9. The free floating mixing blade of claim 8 wherein said elliptical helix includes a major and a minor axis, and wherein said first blade portion starts at a minor axis of said elliptical helix, and wherein said second blade portion terminates at the minor axis of the elliptical helix at a vertically displaced location on the elliptical helix where said first blade portion started.

10. The free floating mixing blade of claim 8 wherein said first blade portion starts at a major axis of the elliptical helix, and wherein said second blade portion terminates at the major axis of the elliptical helix at a vertically displaced location on the elliptical helix where said first blade portion started.

11. The free floating mixing blade of claim 1 wherein said elongated blade member forms a circular helix.

12. The free floating mixing blade of claim 1 wherein the first and second opposed end portions of said elongated blade include a sharp corner portion.

13. The free floating mixing blade of claim 1 including at least one notch formed at a predetermined location along the length of said elongated blade member.

14. The free floating mixing blade of claim 3 wherein said rib portion is greater in thickness as compared to the thickness of said elongated blade member.

15. The free floating mixing blade of claim 4 wherein said first and second blade portions each include at least one opening.

16. The free floating mixing blade of claim 1 wherein said elongated blade member includes a plurality of slits positioned and located at spaced apart locations along the length thereof, said plurality of slits dividing said elongated blade member into a plurality of blade portions.

17. The free floating mixing blade of claim 4 wherein said elongated first and second blade portions form a circular helix.

18. The free floating mixing blade of claim 17 wherein said first blade portion starts at a predetermined location on the circumference of the circle formed by the vertical extension of said first and second blade portions, and wherein said second blade portion terminates at the vertical extension of said same predetermined location on the circumference of the circle at a vertically displaced location on the circular helix where said first blade portion started.

19. A free floating helically shaped mixing blade for use in a mixing chamber for mixing various substances therein, the mixing blade comprising:
an elongated blade member having a length, a width and a slit positioned and located at an intermediate location along the length thereof, said slit dividing said elongated blade member into a first blade portion and a second blade portion, said slit extending partially along the width of said elongated blade member, said first and second blade portions forming a helical shape;
said blade member being positionable within a mixing chamber so as to be wholly contained therein;
said blade member being free floating within the mixing chamber when the mixing chamber is agitated.

20. The free floating mixing blade of claim 19 wherein said first blade portion includes at least one hole extending therethrough and said second blade portion includes at least one hole extending therethrough.

21. The free floating mixing blade of claim 19 including a rib portion extending along the full length of said first blade portion and said second blade portion, said rib portion providing additional support to said blade member.

22. The free floating mixing blade of claim 19 wherein said slit forms a gap between said first blade portion and said blade portion at said slit.

23. The free floating mixing blade of claim 19 wherein said first blade portion and said second blade portion are offset from each other at said slit.

24. The free floating mixing blade of claim 19 wherein said first blade portion and said second blade portion form an elliptical helix.

25. The free floating mixing blade of claim 19 wherein said first blade portion and said second blade portion form a circular helix.

26. The free floating helically shaped mixing blade for use in a mixing chamber for mixing various substances therein, the mixing blade comprising:
an elongated blade member having a length, a width and first and second opposed end portions, said blade member being formed so as to extend from said first end portion to said end portion in a helical configuration, said blade member including a plurality of holes extending therethrough;
said blade member being positionable within a mixing chamber so as to wholly contained therein;
said blade member being free floating within the mixing chamber when the mixing chamber is agitated.

27. The free floating mixing blade of claim 26 wherein said elongated blade member includes a slit positioned and located at an intermediate location along the length thereof, said slit dividing said elongated blade member into a first blade portion and a second blade portion.

28. The free floating mixing blade of claim 27 wherein said slit forms a gap between said first blade portion and said second blade portion at said slit.

29. The free floating mixing blade of claim 28 wherein said first blade portion and said second blade portion are offset from each other at said slit.

30. The free floating mixing blade of claim 26 wherein said elongated blade member forms an elliptical helix.

31. The free floating mixing blade of claim 27 wherein said first and second blade portions form an elliptical helix.

32. The free floating mixing blade of claim 26 wherein said elongated blade member forms a circular helix.

33. The free floating mixing blade of claim 27 wherein said first and second blade portions form a circular helix.

34. A free floating elliptical helix mixing blade for use in a mixing chamber for mixing various substances therein, the mixing blade comprising:
an elongated blade member having a first blade portion and a second blade portion, a length and a width, said first and second blade portions being separated by a slit positioned and located therebetween, said slit extending partially along the width of said blade member;
said first and second blade portions each including a plurality of holes extending therethrough;
said blade member being positionable within a mixing chamber so as to be wholly contained therein;
said blade member being free floating within the mixing chamber when the mixing chamber is agitated.

35. The free floating mixing blade of claim 34 wherein said first and second blade portions circumscribe at least one complete 360° revolution along the length of said first and second blade portions.

36. The free floating mixing blade of claim 34 wherein said elongated blade member includes a rib portion extending along the full length of said blade member, said slit terminating in the vicinity of said rib portion.

37. The free floating mixing blade of claim 34 wherein said first and second blade portions are offset from each other at said slit.

38. The free floating mixing blade of claim 34 wherein said first and second blade portions circumscribe at least one 270 degrees of one revolution along the length of said first and second blade portions.

39. A free-standing circular helix mixing blade for use in a mixing chamber for mixing various substances therein, the mixing blade comprising:
an elongated blade member having a first blade portion and a second blade portion, a length and a width, said first and second blade portions being separated by a slit positioned and located therebetween, said slit extending partially along the width of said blade member;
said first and second blade portions each including a plurality of holes extending therethrough;
said blade member being positionable within a mixing chamber so as to be wholly contained therein;
said blade member being free floating within the mixing chamber when the mixing chamber is agitated.

40. The free floating mixing blade of claim 39 wherein said first and second blade portions circumscribe at least one complete 360° revolution along the length of said first and second blade portions.

41. The free floating mixing blade of claim 39 wherein said elongated blade member includes a rib portion extending along the full length of said blade member, said slit terminating in the vicinity of said rib portion.

42. The free floating mixing blade of claim 39 wherein said first and second blade portions are offset from each other at said slit.

43. The free floating mixing blade of claim 39 wherein said first and second blade portions circumscribe at least about 270 degrees of one revolution along the length of said first and second blade portions.
